(19) United States
(12) Patent Application Publication
(10) Pub. No.: US 2007/0221783 A1
(43) Pub. Date: Sep. 27, 2007

(54) Adaptive landing gear

(76) Inventors: Robert Parks, San Jose, CA (US); Robert Minelli, Burke, VA (US); Stephen Haase, Falls Church, VA (US); Neil Boertlein, Centreville, VA (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/228,350

(22) Filed: Sep. 19, 2005

Related U.S. Application Data
(60) Provisional application No. 60/610,552, filed on Sep. 17, 2004.

(51) Int. Cl. B64C 25/10

(52) U.S. Cl. 244/102 A

(57) ABSTRACT

An adaptive landing gear system for use in an aircraft includes a plurality of leveling struts. Each leveling strut includes an adaptive portion and landing pad. Each adaptive portion includes a fluid reservoir. A change in the volume of fluid in the fluid reservoir is configured to cause a change in extension of the corresponding landing pad. The adaptive portion of each leveling strut is in fluidic connection with the adaptive portion of at least one other leveling strut. The system includes a plurality of valves between the adaptive portions. Compression of the leveling strut forces fluid from the adaptive portion into the adaptive portion of at least one other leveling strut to extend the landing pad of the at least one other leveling strut. The valves prevent fluid from flowing back into the adaptive portion after compression.

This application claims priority under 35 U.S.C. § 119(e) to U.S. Provisional Application No. 60/610,552, filed on Sep. 17, 2004, the entire contents of which are hereby incorporated by reference herein.

### BACKGROUND

1. Field of the Invention

The present invention relates to landing gear systems for aircraft. More particularly, the present invention relates to an auto-leveling and adaptive landing gear system and method for use in an aircraft, such as a vertical takeoff and landing (VTOL) aircraft.

2. Background Information

Vertical takeoff and landing (VTOL) aircraft can be controlled by thrust vectoring applied to the primary lifting jet, where a “jet” can be any high speed air flow in general, not merely a turbojet engine. One advantage of VTOL aircraft is that they do not need large prepared runways for takeoff and landing. However, in conventional implementations, VTOL aircraft have still required relatively smooth and nearly level ground from which to operate. To maximize the utility of the aircraft, it is desirable to be able to operate from a much wider range of surfaces. However, to allow this operation, conventional landing gear must be very wide, and such landing gear configurations add weight and aerodynamic drag that limits the performance of the aircraft. The wider landing gear also makes stowage and ground transport of the aircraft more difficult.

For example, U.S. Pat. No. 4,519,559 to Logan et al. (hereinafter the “Logan patent”) discloses a landing gear for helicopters. However, there are several fundamental differences between helicopters and a thrust vectoring VTOL aircraft or the like. For example, the helicopter uses cyclic pitch control that allows for generating large control moments about the landing gear to ground contact points. As the helicopter leaves the ground, it will rotate about one or more of these contact points. In many thrust vectoring VTOL aircraft, the force centroid of the vectoring thrust is located near the landing gear points, so only minimal control moments can be generated. These VTOL aircraft can have significant aerodynamic lateral forces due to inlet lip flow when taking off in windy conditions. The lateral force can be located near or ahead of the inlet lip, which can give it a very large overturning moment about the landing gear to ground contact points. Consequently, when the landing gear is at least partly in contact with the ground, the thrust vectoring will not generate moments to overcome the overturning moments. Thus, the landing gear must provide these corrective moments for the VTOL aircraft, which is not provided by the landing gear used in helicopters, such as that disclosed by, for example, the Logan patent.

Another difference between helicopters and a thrust vectoring VTOL aircraft is that the much lower RPM of the helicopter rotor requires that the landing gear be compliant in pitch and roll. The resonant frequency of the helicopter rotating about its landing gear needs to be at a frequency that is outside the rotation rate of the rotor. The conventional thrust vectoring VTOL aircraft has a much higher rotor RPM and can have a much stiffer landing gear without encountering the ground resonance problem. Thus, conventional landing gear systems used for helicopters, such as that disclosed by, for example, the Logan patent, are compliant in pitch and roll, which can be considered the helicopter definition of axes. Using such a landing gear system on a VTOL aircraft can result in an aircraft that is prone to flipping over when it tries to take off in windy conditions.

Therefore, there is a need for a lightweight, adaptive landing gear system for VTOL aircraft capable of adapting to the surface it is landing on, while still providing good stability to the aircraft once it is on the ground and high stiffness against lateral overturning moments.

### SUMMARY OF THE INVENTION

An adaptive landing gear system and corresponding method for use in an aircraft, such as, for example, a ducted fan vertical takeoff and landing (VTOL) aircraft or the like, are disclosed. In accordance with exemplary embodiments of the present invention, according to a first aspect of the present invention, an auto-leveling landing gear system for use in an aircraft includes a plurality of leveling struts coupled to the aircraft. Each leveling strut includes an adaptive portion and a landing pad. Each adaptive portion includes a fluid reservoir. A change in a volume of fluid in the fluid reservoir of the adaptive portion is configured to cause a change in extension of the corresponding landing pad of the leveling strut. The adaptive portion of each leveling strut is in fluidic connection with the adaptive portion of at least one other leveling strut. The system includes a plurality of valves in fluidic connection between the adaptive portions of the plurality of leveling struts. For each leveling strut, compression of the leveling strut is configured to force fluid from the adaptive portion of the leveling strut into the adaptive portion of the at least one other leveling strut to extend the landing pad of the at least one other leveling strut. The plurality of valves are configured to prevent fluid from flowing back into the adaptive portion of each leveling strut after compression.

According to the first aspect, the plurality of leveling struts can comprise at least three leveling struts. Alternatively, the plurality of leveling struts can comprise an even number of leveling struts greater than three. The adaptive portion of each leveling strut can be in fluidic connection with the adaptive portion of a substantially diagonally opposing leveling strut of the aircraft. Alternatively, the adaptive portion of each leveling strut can be in fluidic connection with the adaptive portion of each of the plurality of leveling struts. The adaptive portion of each leveling strut can comprise a hydraulic piston device, and the fluid can comprise, for example, a liquid. For example, the hydraulic piston device can comprises either a single-acting hydraulic cylinder or a double-acting hydraulic cylinder. Alternatively, the adaptive portion of each leveling strut can comprise a pneumatic piston device, and the fluid can comprise, for example, a gas. For example, the pneumatic piston device can comprise either a single-acting pneumatic cylinder or a double-acting pneumatic cylinder.

According to the first aspect, each leveling strut can optionally include a shock absorbing portion. The shock absorbing portion of each leveling strut can comprise a shock absorber. For example, the shock absorber can comprise a fluid damper and spring device. The adaptive portion of each leveling strut can be positioned between the landing pad and the shock absorber. Alternatively, the adaptive portion of each leveling strut can be positioned between the shock absorbing portion and the aircraft. The adaptive portion of each leveling strut can comprise a spring device for returning each leveling strut to an original position when at least one of i.) the corresponding valve is opened, and ii.) compression of the leveling strut is released. The shock absorbing portion of each leveling strut can be in fluidic connection with the shock absorbing portion of a diagonally opposing leveling strut of the aircraft. Alternatively, the shock absorbing portion of each leveling strut can be in fluidic connection with the shock absorbing portion of each of the plurality of leveling struts.

According to the first aspect, a valve can be associated with the adaptive portion of each leveling strut. The system can include a second plurality of valves in fluidic connection between the shock absorber portions of the plurality of leveling struts. A valve of the second plurality of valves can be associated with the shock absorbing portion of each leveling strut. Each valve can be associated with a variable orifice for controlling shock absorption damping of a leveling strut. Each valve can comprise, for example, a one-way valve, a manual valve release or the like. The plurality of valves can be closed after all leveling struts have been compressed to isolate each of the plurality of leveling struts upon landing. Each valve can comprise an electric valve. According to such an exemplary embodiment of the first aspect, the system can include a control circuit in electrical communication with each electric valve for controlling the electric valves. The system can include at least one sensor in electrical communication with each of the plurality of leveling struts and the control circuit. The at least one sensor can be configured to detect an internal pressure of the adaptive portion and/or a displacement of the landing pad of each of the plurality of leveling struts. The aircraft can comprise, for example, a VTOL ducted fan aircraft or other suitable type of aircraft.

According to a second aspect of the present invention, an auto-leveling landing gear system for use in an aircraft includes a plurality of means for landing coupled to the aircraft. Each landing means includes a means for adapting and a landing pad means. Each adapting means includes a means for reserving fluid. A change in a volume of fluid in the fluid reserving means of the adapting means is configured to cause a change in extension of the corresponding landing pad means of the landing means. The adapting means of each landing means is in fluidic connection with the adapting means of at least one other landing means. The system includes a plurality of means for restricting fluid flow in fluidic connection between the adapting means of the plurality of landing means. For each landing means, compression of the landing means is configured to force fluid from the adapting means of the landing means into the adapting means of the at least one other landing means to extend the landing pad means of the at least one other landing means. The plurality of fluid flow restricting means are configured to prevent fluid from flowing back into the adapting means of each landing means after compression.

According to the second aspect, the plurality of landing means can comprise at least three landing means. Alternatively, the plurality of landing means can comprise an even number of landing means greater than three. The adapting means of each landing means can be in fluidic connection with the adapting means of a substantially diagonally opposing landing means of the aircraft. Alternatively, the adapting means of each landing means can be in fluidic connection with the adapting means of each of the plurality of landing means. The adapting means of each landing means can comprise a hydraulic piston device, and the fluid can comprise, for example, a liquid. For example, the hydraulic piston device can comprise either a single-acting hydraulic cylinder or a double-acting hydraulic cylinder. The adapting means of each landing means can comprise a pneumatic piston device, and the fluid can comprise, for example, a gas. For example, the pneumatic piston device can comprises either a single-acting pneumatic cylinder or a double-acting pneumatic cylinder.

According to the second aspect, each landing means can optionally include means for absorbing shock. The shock absorbing means of each landing means can comprise a shock absorber means. For example, the shock absorber means can comprise a fluid damper and spring means. The adapting means of each landing means can be positioned between the landing pad means and the shock absorber means. Alternatively, the adapting means of each landing means can be positioned between the shock absorbing means and the aircraft. The adapting means of each landing means can comprise a spring means for returning each landing means to an original position when at least one of i.) the corresponding fluid flow restricting means is opened, and ii.) compression of the landing means is released. The shock absorbing means of each landing means can be in fluidic connection with the shock absorbing means of a diagonally opposing landing means of the aircraft. Alternatively, the shock absorbing means of each landing means can be in fluidic connection with the shock absorbing means of each of the plurality of landing means.

According to the second aspect, a fluid flow restricting means can be associated with the adapting means of each landing means. The system can include a second plurality of means for restricting fluid flow in fluidic connection between the shock absorber means of the plurality of landing means. A fluid flow restricting means of the second plurality of means for restricting fluid flow can be associated with the shock absorbing means of each landing means. Each fluid flow restricting means can be associated with a variable orifice for controlling shock absorption damping of a landing means. Each fluid flow restricting means can comprise a one-way means for restricting fluid flow. Each one-way fluid flow restricting means can comprise a means for manually releasing a fluid flow restricting means. The plurality of fluid flow restricting means can be closed after all landing means have been compressed to isolate each of the plurality of landing means upon landing. Each fluid flow restricting means can comprise an electric means for restricting fluid flow. According to such an exemplary embodiment of the second aspect, the system can include a control means in electrical communication with each electric fluid flow restricting means for controlling the electric fluid flow restricting means. The system can include at least one means for sensing in electrical communication with each of the plurality of landing means and the control means. The at least one sensing means can be configured to detect an internal pressure of the adapting means and/or a displacement of the landing pad means of each of the plurality of landing means. The aircraft can comprise, for example, a VTOL ducted fan aircraft or other suitable type of aircraft.

According to a third aspect of the present invention, a method of auto-leveling landing gear of an aircraft includes the steps of: a.) fluidly connecting an adaptive portion of each of a plurality of leveling struts to the adaptive portion of at least one other leveling strut, wherein each adaptive portion comprises a fluid reservoir, wherein each leveling strut comprises a landing pad, wherein a change in a volume of fluid in the fluid reservoir of the adaptive portion is configured to cause a change in extension of the corresponding landing pad of the leveling strut, and wherein for each of the plurality of leveling struts, the method comprises the steps of: b.) compressing leveling strut; c.) forcing fluid from the adaptive portion of the leveling strut into the adaptive portion of the at least one other leveling strut to extend the landing pad of the at least one other leveling strut; and d.) preventing fluid from flowing back into the adaptive portion of each leveling strut after step (b).

According to the third aspect, the plurality of leveling struts can comprise at least three leveling struts. Alternatively, the plurality of leveling struts can comprise an even number of leveling struts greater than three. Step (a) can include the step of: e.) fluidly connecting the adaptive portion of each leveling strut to the adaptive portion of a substantially diagonally opposing leveling strut of the aircraft. Alternatively, step (a) can include the step of: f.) fluidly connecting the adaptive portion of each leveling strut to the adaptive portion of each of the plurality of leveling struts. The adaptive portion of each leveling strut can comprise a hydraulic piston device, and the fluid can comprise, for example, a liquid. For example, the hydraulic piston device can comprise either a single-acting hydraulic cylinder or a double-acting hydraulic cylinder. The adaptive portion of each leveling strut can comprise a pneumatic piston device, and the fluid can comprise, for example, a gas. For example, the pneumatic piston device can comprise one of a single-acting pneumatic cylinder and a double-acting pneumatic cylinder.

According to the third aspect, each leveling strut can optionally include a shock absorbing portion. For example, the shock absorbing portion can comprise a shock absorber. For example, the shock absorber can comprise a fluid damper and spring device. According to the third aspect, the method can include the step of: g.) positioning the adaptive portion of each leveling strut between the landing pad and the shock absorber. Alternatively, the method can include the step of: h.) positioning the adaptive portion of each leveling strut between the shock absorbing portion and the aircraft. The method can include the step of: i.) controlling shock absorption damping of each leveling strut. The method can include the step of: j.) fluidly connecting the shock absorbing portion of each leveling strut to the shock absorbing portion of a diagonally opposing leveling strut of the aircraft. Alternatively, the method can include the step of: k.) fluidly connecting the shock absorbing portion of each leveling strut to the shock absorbing portion of each of the plurality of leveling struts.

According to third aspect, the method can include the step of: 1.) returning each leveling strut to an original position. Step (d) can include the step of: m.) fluidly connecting a plurality of valves between the adaptive portions of the plurality of leveling struts. A valve of the plurality of valves can be associated with the adaptive portion of each leveling strut. Each valve can comprise, for example, a one-way valve. For example, each one-way valve can comprise a manual valve release. The method can include the steps of: n.) controlling each valve to prevent fluid from flowing back into the adaptive portion of each leveling strut; and o.) fluidly connecting a plurality of valves between the shock absorber portions of the plurality of leveling struts. A valve of the plurality of valves can be associated with the shock absorbing portion of each leveling strut. Step (d) can be performed after all leveling struts have been compressed to isolate each of the plurality of leveling struts upon landing. Step (d) can comprise the step of: p.) detecting an internal pressure of the adaptive portion and/or a displacement of the landing pad of each of the plurality of leveling struts. The aircraft can comprise, for example, a VTOL ducted fan aircraft or other suitable type of aircraft.

### BRIEF DESCRIPTION OF THE DRAWINGS

Other objects and advantages of the present invention will become apparent to those skilled in the art upon reading the following detailed description of preferred embodiments, in conjunction with the accompanying drawings, wherein like reference numerals have been used to designate like elements, and wherein:

FIG. 1 is a diagram illustrating an auto-leveling landing gear system for use in an aircraft, in accordance with an exemplary embodiment of the present invention.

FIG. 2 is a diagram illustrating a leveling strut, in accordance with an exemplary embodiment of the present invention.

FIG. 3 is a flowchart illustrating steps for auto-leveling landing gear of an aircraft, in accordance with an exemplary embodiment of the present invention.

### DETAILED DESCRIPTION OF THE PREFERRED EMBODIMENTS

Exemplary embodiments of the present invention are directed to an adaptive, auto-leveling landing gear system for use in an aircraft, such as, for example, a ducted fan vertical takeoff and landing (VTOL) aircraft or any other suitable type of aircraft. According to exemplary embodiments, a plurality of landing gear struts can radiate out from the aircraft body. For example, an even number of struts can be used, although any number of landing gear struts greater than or equal to three can be used. Each landing gear strut includes an adaptive portion and a landing pad. According to exemplary embodiments, the adaptive portion can comprise, for example, a hydraulic-or pneumatic-piston-type mechanism or the like. The adaptive portion can include upper and lower chambers separated by a movable piston. The upper chamber can be connected to the upper chambers of the adaptive portions of the other landing gear struts. The lower chamber can be connected to the lower chambers of the adaptive portions of the other landing gear struts.

According to an exemplary embodiment of the present invention, the adaptive portion of a given landing gear strut can be in fluidic connection with the adaptive portion of a landing gear strut that is substantially diagonally opposite the given landing gear strut on the aircraft. Such an embodiment can provide good performance when landing on, for example, smooth, but inclined, surfaces. According to an alternative exemplary embodiment of the present invention, the adaptive portion of each landing gear strut can be in fluidic connection with the adaptive portions of all or substantially all of the other landing gear struts. Such an alternative exemplary embodiment can provide good performance when landing on, for example, uneven, but relatively level, surfaces.

According to an exemplary embodiment, each landing gear strut can optionally include a shock absorbing portion. The shock absorbing portion can comprise, for example, a vertical telescoping shock absorber, including the corresponding landing pads, that can be used at the end of each landing gear strut. For example, attached to the shock absorbing portion can be a hydraulic cylinder that performs the adaptive function. However, any suitable shock absorber can be used, such as, for example, a fluid damper and spring system.

According to exemplary embodiments, when the aircraft is landing on a sloped or uneven surface, the landing pad of one landing gear strut can contact the surface before the other landing gear struts. With conventional landing gear, the main body of the aircraft would start to rotate, and the rotational speed can promote tipping over. However, according to exemplary embodiments, the landing pad of the landing gear strut may stop, but the rotational motion is taken up by the adaptive portion, pushing the piston up. The movement of the piston causes the fluid in the adaptive portion to leave the top of the adaptive portion and be forced into the adaptive portions of the interconnected landing gear struts. The fluid motion pushes the landing pads attached to the other landing gear struts downwards. The main body of the aircraft is thereby substantially prevented from rotating. The next landing pad will then touch the surface, and a similar process occurs with the distribution of fluid to the adaptive portions of the other landing gear struts and the corresponding extensions of the landing pads. Thus, any landing gear struts that do not have their landing pads on the surface will have their landing pads pushed downwards, while no loads are transmitted to the aircraft body.

Once all of the landing pads are on the surface, a valve system can isolate the individual adaptive portions of the landing gear struts so that the adaptive portions stop moving and the load is taken up by the landing gear struts, for example, such as by the corresponding shock absorbing portions. Consequently, the loaded position of the landing gear struts is such that all landing pads are in contact with the surface and the aircraft fuselage is still substantially upright, providing a smooth deceleration of the aircraft body with little or no tendency to tip over.

According to an exemplary embodiment of the present invention, a control circuit on the aircraft can be configured to determine the proper time to close the valves that isolate the adaptive portions of the landing gear struts. Such an exemplary embodiment can provide full control of the landing gear system and can be optimized to handle a variety of surface terrain types. According to an alternative exemplary embodiment of the present invention, each landing gear strut can have its own valve that is actuated by the local displacement of the adaptive portion. As soon as that landing gear strut starts to be displaced, a one way check valve or the like can be engaged that allows the adaptive portion of that landing gear strut to be displaced upwards, but not downwards. As second and later landing gear struts contact the surface, they can also be displaced upwards, with the valves preventing subsequent downward displacement. The fluid from the adaptive portions of the landing gear struts that are in contact with the surface can be transferred to the adaptive portions of any landing gear struts not yet in contact with the surface, causing the landing pads of those landing gear struts to extend.

When all landing gear struts are in contact with the surface, all valves are actuated, no adaptive portion moves downward, and all of the load is transferred to the landing gear struts (e.g., to the shock absorbing portions). Such a valve embodiment can also include a manual valve release so that, for example, a ducted fan VTOL aircraft or the like can be manually rotated to a level attitude after landing and moved to a new location. The adaptive portions can incorporate springs or the like to return the landing gear struts to their nominal positions when the control valves are opened, for example, by manual operation, by operation of the control circuit, or by the lack of loads on the landing gear struts once the aircraft is in flight.

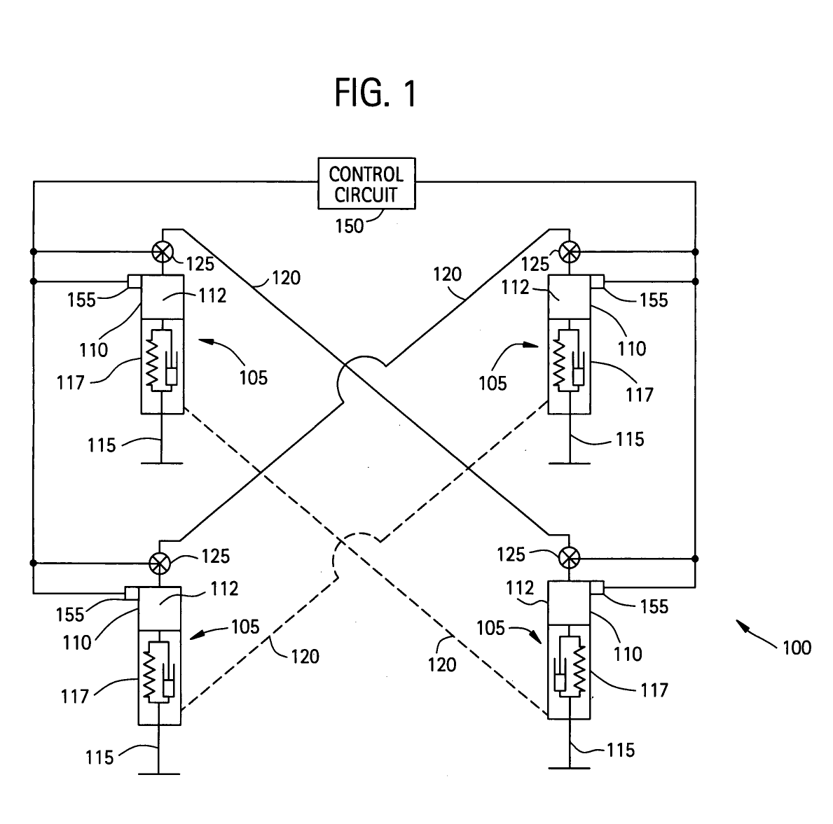

These and other aspects of the present invention will now be described in greater detail. FIG. 1 is a diagram illustrating an auto-leveling landing gear system 100 for use in an aircraft, in accordance with an exemplary embodiment of the present invention. The landing gear system 100 includes a plurality of leveling struts 105 that can be coupled to an aircraft. For example, three or more leveling struts 105 can be used. According to an exemplary embodiment, any even number of leveling struts 105 greater than three can be used. However, any suitable number of leveling struts 105 can be used in the landing gear system 100.

Each leveling strut 105 includes an adaptive portion 110 and a landing pad 115 for contact with a surface (e.g., the ground or other terrain). The landing pad 115 is attached or otherwise connected to the adaptive portion 110, as described in more detail below. The landing pad 115 can comprise any suitable type of pad, wheel, cushion or the like. Each adaptive portion 110 includes a fluid reservoir 112. According to exemplary embodiments, a change in the volume of fluid in the fluid reservoir 112 of the adaptive portion 110 is configured to cause a change in extension of the corresponding landing pad 115 of the leveling strut 105 (e.g., an increase in the amount of fluid in the fluid reservoir 112 can cause the corresponding landing pad 115 to be extended). The adaptive portion 110 of each leveling strut 115 is in fluidic connection with the adaptive portion 110 of at least one other leveling strut 105 using, for example, fluidic connections 120. The fluidic connections 120 can comprise any suitable type of conduit that is capable of conveying a fluid (e.g., a liquid or a gas), such as, for example, a hose, a pipe or other like conduit.

The landing gear system 100 includes a plurality of valves 125 in fluidic connection between the adaptive portions 110 of the plurality of leveling struts 105. A valve 125 can be associated with the adaptive portion 110 of each leveling strut 105, although a central valve can be used for all leveling struts 105. According to exemplary embodiments, for each leveling strut 105, compression of the leveling strut 105 (e.g., resulting from the landing pad 115 contacting the surface) is configured to force fluid from the adaptive portion 110 of the leveling strut 105 (e.g., via fluidic connections 120) into the adaptive portion 105 of at least one other leveling strut 105 to extend the landing pad 115 of the at least one other leveling strut 105. The plurality of valves 125 are configured to prevent fluid from flowing back into the adaptive portion 110 of each leveling strut 105 after compression.

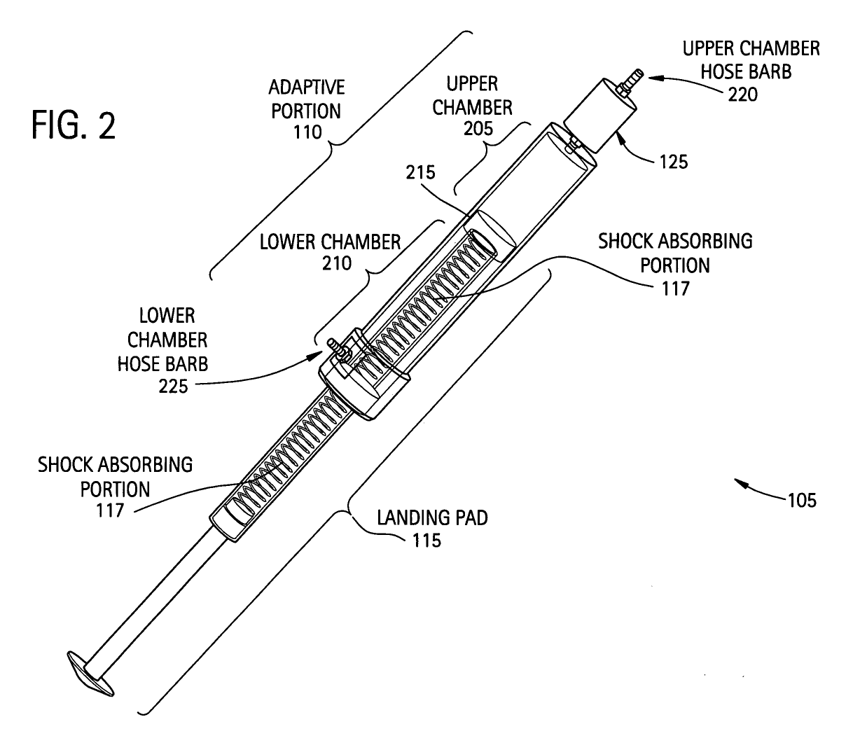

The adaptive portion 110 of the leveling strut 105 can comprise any suitable type of adaptive mechanism capable of extending the landing pad 115 when fluid is forced into the corresponding fluid reservoir 112. For purposes of illustration and not limitation, FIG. 2 is a diagram illustrating a leveling strut 105, in accordance with an exemplary embodiment of the present invention. For example, the adaptive portion 110 of each leveling strut 105 can comprise a hydraulic piston device or the like. In such an exemplary embodiment, the fluid contained in the fluid reservoir 112 can be any suitable type of liquid that can be used with hydraulic devices. According to one exemplary embodiment, the hydraulic piston device can comprise a double-acting hydraulic cylinder or the like. For such an exemplary embodiment, the hydraulic piston device can comprise an upper chamber 205 and a lower chamber 210 that are separated by, for example, a movable piston 215. The landing pad 115 can be, for example, at least partially embedded within the adaptive portion 110, such as, for example, within the lower chamber 210 of the hydraulic piston device and attached or otherwise connected to the piston 215. Thus, as the amount of fluid in the fluid reservoir 112 of the adaptive portion 110 of the leveling strut 105 increases, the landing pad 115 will be correspondingly pushed or otherwise extended from the leveling strut 105.

According to an exemplary embodiment, the adaptive portion 110 of each leveling strut 105 can be in fluidic connection with the adaptive portion 110 of a substantially diagonally opposing leveling strut 105 of the aircraft. Such an exemplary embodiment is illustrated in FIG. 1. For example, the upper chamber 205 of the adaptive portion 110 of a given leveling strut 105 can be connected (e.g., via upper chamber hose barb 220 and fluidic connections 120) to the upper chamber 205 of the adaptive portion 110 of the leveling strut 105 that is substantially diagonally opposite the given leveling strut 105. Additionally, the lower chamber 210 of the adaptive portion 110 of a given leveling strut 105 can be connected (e.g., via lower chamber hose barb 225 and fluidic connections 120) to the lower chamber 210 of the adaptive portion 110 of the leveling strut 105 that is substantially diagonally opposite the given leveling strut 105. Such an exemplary embodiment can provide good performance when landing on, for example, smooth, but inclined, surfaces.

However, according to an alternative exemplary embodiment, the adaptive portion 110 of each leveling strut 105 can be in fluidic connection with the adaptive portion 110 of each, any, or any combination of the plurality of leveling struts 105. For example, the upper chamber 205 of the adaptive portion 110 of a given leveling strut 105 can be in fluidic connection to the upper chamber 205 of the adaptive portion 110 of each, any, or any combination the other leveling struts 105. Additionally, the lower chamber 210 of the adaptive portion 110 of a given leveling strut 105 can be connected to the lower chamber 210 of the adaptive portion 110 of each, any, or any combination the other leveling struts 105. Such an alternative exemplary embodiment can provide good performance when landing on, for example, uneven, but relatively level, surfaces.

According to an exemplary embodiment, each leveling strut 105 can optionally include a shock absorbing portion 117. The shock absorbing portion 117 can comprise, for example, a shock absorber. However, as illustrated in FIG. 2, the shock absorbing portion 117 can be comprised of any suitable type of shock absorber mechanism, such as, for example, a fluid damper and spring device, any suitable type of telescoping shock absorber or the like.

The fluidic interconnectivity of the adaptive portions 110 of the leveling struts 105 functions to reduce rotational moments and potential tipping of aircraft in the following manner. When an aircraft with the landing gear system 100 is landing on a sloped or otherwise uneven surface, the landing pad 115 of one of the leveling struts 105 will generally contact the surface before the landing pads 115 of the other leveling struts 105. The landing pad 115 stops, but the motion is taken up by the adaptive portion 110 of the leveling strut 105, pushing the piston 215 upwards (e.g., in a direction away or substantially opposite from the landing surface). The upward movement of the piston 215 causes the fluid to leave the fluid reservoir 112 in the upper chamber 205 and be forced into the fluid reservoirs 112 in the upper chambers 205 of the adaptive-portions 110 of the one or more interconnected leveling struts 105 that have not yet contacted the surface. Additionally, the upward motion of the piston 215 can cause fluid to be drawn into the lower chamber 210 of the adaptive portion 110 of the leveling strut 105 from the lower chambers 210 of the adaptive portions 110 of the one or more interconnected leveling struts 105 that have not yet contacted the surface. The fluid motion pushes the corresponding pistons 215 of the interconnected leveling struts 105 downwards (e.g., in a direction substantially towards the landing surface), along with the corresponding attached landing pads 115, thereby causing an extension of the landing pad 115 of those leveling struts 105. Such movement of the leveling struts 105 substantially prevents movement of the main body of the aircraft.

As landing of the aircraft continues, the landing pad 115 of the next (now at least partially extended) leveling strut 105 will touch the surface. Again, the landing pad 115 stops, but the piston 215 of the next leveling strut 105 is pushed upwards. The upward movement of the piston 215 causes the fluid to leave the fluid reservoir 112 and be forced into the fluid reservoirs 112 of the adaptive portions 110 of the one or more interconnected leveling struts 105 that have not yet contacted the surface. Additionally, the upward motion of the piston 215 can cause fluid to be drawn into the lower chamber 210 of the adaptive portion 110 of the next leveling strut 105 from the lower chambers 210 of the adaptive portions 110 of the one or more interconnected leveling struts 105 that have not yet contacted the surface. The fluid motion pushes the corresponding pistons 215 of the interconnected leveling struts 105 downwards, along with the corresponding landing pads 115, thereby causing an extension of the landing pads 115 of those leveling struts 105. Thus, any leveling struts 105 that do not have their landing pads 115 on the surface will be pushed downwards. The process continues for each remaining leveling strut 105 until all landing pads 115 have contacted the surface.

Once all landing pads 115 are on the surface, the valves 125 are configured to isolate the adaptive portions 110 of each of the leveling struts 105 so that the adaptive portions 110 cease movement and the load is taken up by the corresponding leveling struts 105 (e.g., by the shock absorbing portions 117 of the leveling struts 105). At such point, the loaded position of the leveling struts 105 is such that all landing pads 115 are in contact with the surface and the fuselage of, for example, a VTOL aircraft or the like is still substantially upright. Thus, the landing gear system 100 according to exemplary embodiments can provide a smooth deceleration of the body of the aircraft with little or no tendency for tipping over.

According to exemplary embodiments, to assist in providing rotational stabilization of the body of the aircraft after all landing pads 115 are on the surface, the valves 125, such as cut-off or one-way valves or the like, can be used in the fluidic connections 120 between the adaptive portions 110 of the leveling struts 105. Each corresponding valve 125 can be open during the initial touchdown, allowing the adaptive behavior described above. However, once the leveling strut 105 has adapted to the surface slope or contour, the valve 125 of the corresponding leveling strut 105 can be closed. Thus, the plurality of valves 125 can be closed after the landing pads 115 of all of the leveling struts 105 have been compressed to isolate each of the plurality of leveling struts 105 upon landing.

The plurality of valves 125 can be implemented in any suitable manner. For example, each valve 125 can comprise any suitable type of electric valve or the like. Referring to FIG. 1, according to such an exemplary embodiment, the landing gear system 100 can comprise a control circuit 150, in electrical communication with each electric valve 125, for controlling the electric valves 125. The control circuit 150 can be located in or on, for example, the body or fuselage of the aircraft. Additionally, the landing gear system 100 can include at least one sensor 155 in electrical communication with each of the plurality of leveling struts 105 and the control circuit 150. For example, each leveling strut 105 can include an associated sensor 155, although any suitable number of such sensors 155 can be used. The sensors 155 can be configured to detect, for example, an internal pressure of the adaptive portion 110 and/or a displacement of the landing pad 115 of each of the plurality of leveling struts 105 from their nominal positions. By monitoring the sensors 155, the control circuit 150 can be configured to determine the proper time to close each of the electric valves 125 to isolate the appropriate leveling struts 105, based upon, for example, the corresponding internal pressure and/or displacement of each leveling strut 105. For example, a look-up table or the like can be stored in the control circuit 150. The look-up table can list the shut off times for a valve 125 corresponding to various values of internal pressure and/or displacement, although other suitable algorithms can be used. By modifying, for example, the entries in the look-up table or the like, the control circuit 150 can thereby be configured to handle a variety of terrain types with surfaces of varying slopes and contours.

According to an alternative exemplary embodiment, each leveling strut 105 can include a valve 125 that can be actuated, for example, by the local displacement of the corresponding adaptive portion 110 away from the nominal position, by the force between the leveling strut and the body of the aircraft (e.g., there will be such a small force even when the leveling struts 105 are in the process of adapting to the surface), by the pressure of the landing pads 115 or the like. For example, as soon as a leveling strut 105 starts to be displaced away from its nominal position, a one-way check valve 125 or the like can be engaged that allows the adaptive portion 110 of the leveling strut 105 to be displaced upwards, but not downwards. Thus, the leveling strut 105 that contacts the surface first can be allowed to be displaced freely. As second and later leveling struts 105 contact the surface, those leveling struts 105 can also be displaced upwards. The fluid from the fluid reservoirs 112 from all leveling struts 105 in contact with the surface can be transferred to any leveling struts 105 not yet in contact with the surface, causing landing pads 115 of those leveling struts 105 to extend. When all leveling struts 105 are in contact with the surface, all valves 125 can be actuated, and no adaptive portions 110 can move downwards. Accordingly, all or substantially all of the load is thereby transferred to the leveling struts 105 (e.g., to the shock absorbing portions 117 of the leveling struts 105). According to such an alternative exemplary embodiment, the valves 125 can also incorporate a manual valve release. For example, for VTOL aircraft or the like, the manual valve release(s) can be used so that the aircraft can be manually rotated to a level attitude after landing and moved to a new location.

According to an additional exemplary embodiment, the control circuit 150 can be configured to change or otherwise alter the fluidic coupling of the leveling struts 105 (e.g., by suitable manipulation of the valves 125) based on, for example, prior knowledge of characteristics of the landing area or other suitable information that has been stored in, detected by or otherwise conveyed to the control circuit 150 (e.g., by the operator of the aircraft). By altering the fluidic coupling of the leveling struts 105, the landing gear system 100 can be configured to handle varied landing surfaces, whether uneven, sloped or some combination thereof.

According to an exemplary embodiment, the adaptive portions 110 of each of the leveling struts 105 can include a spring or other like device for returning each leveling strut 105 to its original or otherwise nominal position when the corresponding valve 125 is opened (e.g., manually or by the control circuit 150) and/or compression of the leveling strut 105 is released or otherwise removed (e.g., by the lack of loads once the aircraft is in flight). If necessary, a pump or other like device can be used to move fluid between the adaptive portions 110 to redistribute the fluid to the fluid reservoirs 112 after landing.

As discussed with respect to FIG. 2, the adaptive portion 110 of each leveling strut 105 can comprise a double-acting hydraulic cylinder or the like. According to an alternative exemplary embodiment, the adaptive portion 110 of each leveling strut 105 can comprise a single-acting hydraulic cylinder or the like. According to another alternative exemplary embodiment, the adaptive portion 110 of each leveling strut 105 can comprise a pneumatic piston device or the like. In such an alternative exemplary embodiment, the fluid contained in the fluid reservoir 112 can be any suitable type of gas that can be used with pneumatic devices. According to one exemplary embodiment, the pneumatic piston device can comprise a double-acting pneumatic cylinder or the like. The double-acting pneumatic cylinder can comprise upper and lower chambers and be in fluidic connection with other pneumatic cylinders as illustrated in, for example, FIGS. 1 and 2. Since the gas is compressible, even after the one-way valves 125 are activated, there can be additional displacement that can be used for additional shock absorbing capabilities. Accordingly, each one-way check value 125 can be paralleled with a small opening orifice. The orifice size can be tailored or otherwise configured to trade adaptivity versus shock absorption. In other words, each valve 125 can be associated with a variable orifice for controlling shock absorption damping of a leveling strut 105. The orifice size can be varied as a function of, for example, the displacement of the adaptive portion 110 and/or the adaptive portion 110 compression velocity, or the like. It is to be noted that the pneumatic system may need to be pressurized even with no load. For example, the double-acting pneumatic cylinders can give zero net load on the leveling struts 105 while the valves 125 are open. In addition, the pneumatic cylinders can include a spring or other like device for returning each leveling strut 105 to its original or otherwise nominal position.

According to an alternative exemplary embodiment, the adaptive portion 110 of each leveling strut 105 can comprise a single-acting pneumatic cylinder or the like. In such an alternative embodiment, the static pressurization of the system can cause all leveling struts 105 to be fully extended when the valves 125 are open, and the first leveling strut 105 to contact the surface can produce minimal rotational moments about the body of the aircraft as it is compressed. However, such an alternative exemplary embodiment has an advantage of combining the adaptive and shock absorbing portions 110 and 117 into a single cylinder, thus saving cost and weight. As described above, it may be desirable to have a variable orifice in parallel with a one-way valve 125 to control the shock absorption damping.

According to exemplary embodiments, the adaptive portion 110 can be installed in any suitable location relative to the landing pad 115. For example, as illustrated in FIG. 2, the adaptive portion 110 can be located substantially concentric around the landing pad 115. Alternatively, the adaptive portion 110 can be located between the landing pad 115 (and shock absorbing portion 117, if resident) and the body or fuselage of the aircraft. Alternatively, if a shock absorbing portion 117 is used, the adaptive portion 110 can be located between the shock absorbing portion 117 and the landing pad 115. Those of ordinary skill will recognize that other configurations of the adaptive portion 110, shock absorbing portion 117 and landing pad 115 relative to each other and to the body of the aircraft can be used. For example, the leveling struts 105 can be attached to the wings of the aircraft (e.g., at the tips of the wings or anywhere along the length of the wings), to the body of the aircraft, to a combination of the wings or body, or any other suitable location on the aircraft. The aircraft can comprise any suitable type of aircraft that can be configured to use the landing gear system 100 according to exemplary embodiments, such as, for example, a ducted fan aircraft, VTOL aircraft, a ducted fan VTOL aircraft or the like.

Thus, the landing gear system 100 according to exemplary embodiments can automatically adapt to uneven or sloped surfaces. Additionally, when landing, the landing gear system 100 can transfer minimal rotational moments to the body of the aircraft, thus minimizing the chances of the aircraft tipping over. The adaptive feature of the landing gear system 100 can allow for a smaller spacing of the landing pads 115, thereby resulting in shorter leveling struts 105, less weight and less aerodynamic drag.

According to an exemplary embodiment, the control circuit 150 can be comprised of any suitable type of electrical or electronic component or device that is capable of performing the functions associated with the control circuit 150. However, the control circuit 150 can be comprised of any combination of hardware, firmware and software that is capable of performing the function associated with the control circuit 150. The control circuit 150 can also comprise any suitable type of pneumatic, hydraulic or fluidic computer (e.g., servo valves) in addition or alternatively to the combination of hardware, firmware and software. Additionally, the control circuit 150 can be in communication with each valve 125 and sensor 155 using any appropriate type of electrical or appropriate (e.g., pneumatic, hydraulic or fluidic) connection that is capable of carrying electrical or appropriate (e.g., pneumatic, hydraulic or fluidic) information. Each sensor 155 can be any suitable type of electrical, electronic, electromechanical, pneumatic, hydraulic or fluidic sensor device that is capable of detecting, for example, the internal pressure of the adaptive portion 110, the displacement of the landing pad 115 of each of the plurality of leveling struts 105 from their nominal positions, or any other suitable characteristics or values.

Alternatively, the control circuit 150 can comprise a microprocessor and associated memory that stores the steps of a computer program to perform the functions of the control circuit 150. The microprocessor can be any suitable type of processor, such as, for example, any type of general purpose microprocessor or microcontroller, a digital signal processing (DSP) processor, an application-specific integrated circuit (ASIC), a programmable read-only memory (PROM), an erasable programmable read-only memory (EPROM), an electrically-erasable programmable read-only memory (EEPROM), a computer-readable medium, or the like. The memory can be any suitable type of computer memory or any other type of electronic storage medium, such as, for example, read-only memory (ROM), random access memory (RAM), cache memory, compact disc read-only memory (CDROM), electro-optical memory, magneto-optical memory, or the like. As will be appreciated based on the foregoing description, the memory can be programmed using conventional techniques known to those having ordinary skill in the art of computer programming. For example, the actual source code or object code of the computer program can be stored in the memory.

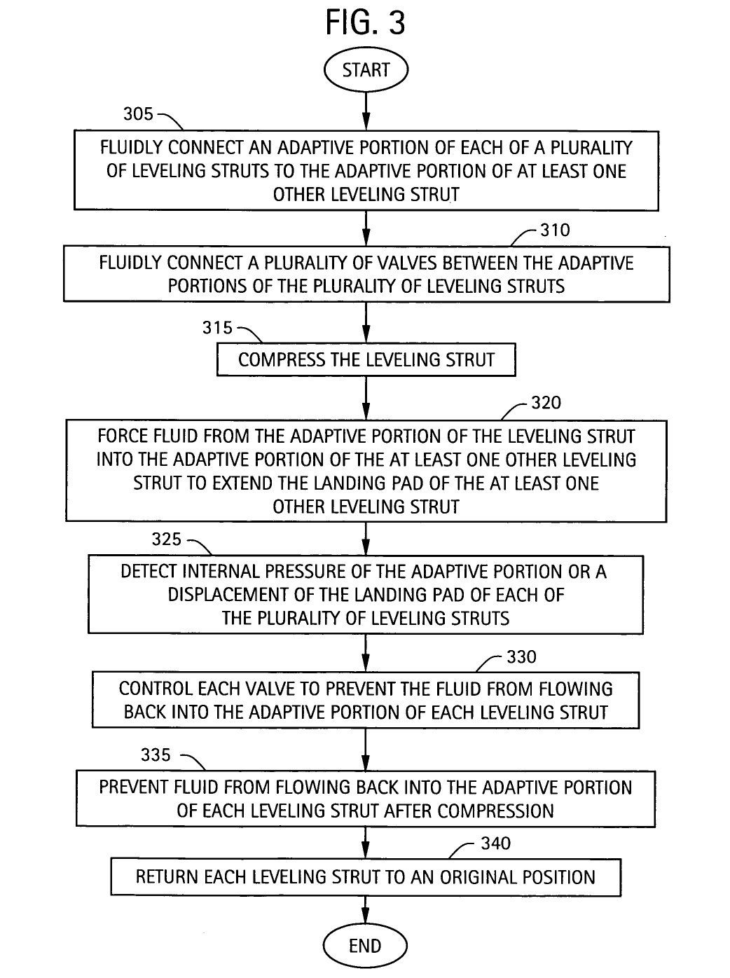

FIG. 3 is a flowchart illustrating steps for auto-leveling landing gear of an aircraft, in accordance with an exemplary embodiment of the present invention. In step 305, the adaptive portion of each of a plurality of leveling struts are fluidly connected to the adaptive portion of at least one other leveling strut. Each adaptive portion includes a fluid reservoir. Each leveling strut includes a landing pad, and, optionally, a shock absorbing portion. According to exemplary embodiments, a change in the volume of fluid in the fluid reservoir of the adaptive portion is configured to cause a change in extension of the corresponding landing pad of the leveling strut. According to an exemplary embodiment of the present invention, the adaptive portion of each leveling strut can be fluidly connected to the adaptive portion of a substantially diagonally opposing leveling strut of the aircraft. According to an alternative exemplary embodiment, the adaptive portion of each leveling strut can be fluidly connected to the adaptive portion of each of the plurality of leveling struts.

In step 310, a plurality of valves can be fluidly connected between the adaptive portions of the plurality of leveling struts. According to an exemplary embodiment, a valve of the plurality of valves can be associated with the adaptive portion of each leveling strut, although any suitable number of valves can be used. For example, each valve can comprise a one-way value (e.g., a one-way check valve) or the like. For example, the one-way valve can comprise a manual valve release or the like.

For each of the plurality of leveling struts, in step 315, the leveling strut is compressed. In step 320, fluid is forced from the adaptive portion of the leveling strut into the adaptive portion of the at least one other leveling strut to extend the landing pad of the at least one other leveling strut. In step 325, the internal pressure of the adaptive portion and/or the displacement of the landing pad of each of the plurality of leveling struts can be detected. In step 330, each valve can be controlled (e.g., closed) to prevent fluid from flowing back into the adaptive portion of each leveling strut. In step 335, the fluid is prevented from flowing back into the adaptive portion of each leveling strut after compression of the leveling strut. For example, the fluid can be prevented from flowing back after all leveling struts have been compressed to isolate each of the plurality of leveling struts upon landing. After landing and all leveling struts are in contact with the surface, in step 340, each leveling strut can be returned to its original position.

Some or all of the steps of a computer program as illustrated in FIG. 3 for auto-leveling landing gear of an aircraft can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. As used herein, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium can include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM).

Exemplary embodiments of the present invention can be used in any suitable type of aircraft, such as, for example, a ducted fan aircraft, VTOL aircraft, a ducted fan VTOL aircraft or the like. For example, the adaptive landing gear system according to exemplary embodiments can be used in aircraft that can be susceptible to rotational moments and tipping over when landing on uneven or sloped surfaces, and/or that require smaller spacing of the landing pads, less weight and less aerodynamic drag.

It will be appreciated by those of ordinary skill in the art that the present invention can be embodied in various specific forms without departing from the spirit or essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

All United States patents and applications, foreign patents, and publications discussed above are hereby incorporated herein by reference in their entireties.

What is claimed is:

1. An auto-leveling landing gear system for use in an aircraft, comprising:
a plurality of leveling struts coupled to the aircraft,
wherein each leveling strut comprises an adaptive portion and a landing pad,
wherein each adaptive portion comprises a fluid reservoir,
wherein a change in a volume of fluid in the fluid reservoir of the adaptive portion is configured to cause a change in extension of the corresponding landing pad of the leveling strut, and
wherein the adaptive portion of each leveling strut is in fluidic connection with the adaptive portion of at least one other leveling strut; and
a plurality of valves in fluidic connection between the adaptive portions of the plurality of leveling struts,
wherein for each leveling strut, compression of the leveling strut is configured to force fluid from the adaptive portion of the leveling strut into the adaptive portion of the at least one other leveling strut to extend the landing pad of the at least one other leveling strut, and
wherein the plurality of valves are configured to prevent fluid from flowing back into the adaptive portion of each leveling strut after compression.

2. The system of claim 1, wherein the plurality of leveling struts comprises at least three leveling struts.

3. The system of claim 1, wherein the plurality of leveling struts comprises an even number of leveling struts greater than three.

4. The system of claim 3, wherein the adaptive portion of each leveling strut is in fluidic connection with the adaptive portion of a substantially diagonally opposing leveling strut of the aircraft.

5. The system of claim 1, wherein the adaptive portion of each leveling strut is in fluidic connection with the adaptive portion of each of the plurality of leveling struts.

6. The system of claim 1, wherein the adaptive portion of each leveling strut comprises a hydraulic piston device, and
wherein the fluid comprises a liquid.

7. The system of claim 6, wherein the hydraulic piston device comprises one of a single-acting hydraulic cylinder and a double-acting hydraulic cylinder.

8. The system of claim 1, wherein the adaptive portion of each leveling strut comprises a pneumatic piston device, and
wherein the fluid comprises a gas.

9. The system of claim 8, wherein the pneumatic piston device comprises one of a single-acting pneumatic cylinder and a double-acting pneumatic cylinder.

10. The system of claim 1, wherein each leveling strut comprises a shock absorbing portion.

11. The system of claim 10, wherein the shock absorbing portion comprises a shock absorber.

12. The system of claim 11, wherein the shock absorber comprises a fluid damper and spring device.

13. The system of claim 11, wherein the adaptive portion of each leveling strut is positioned between the landing pad and the shock absorber.

14. The system of claim 10, wherein the adaptive portion of each leveling strut is positioned between the shock absorbing portion and the aircraft.

15. The system of claim 1, wherein the adaptive portion of each leveling strut comprises a spring device for returning each leveling strut to an original position when at least one of i.) the corresponding valve is opened, and ii.) compression of the leveling strut is released.

16. The system of claim 1, wherein a valve is associated with the adaptive portion of each leveling strut.

17. The system of claim 1, wherein each valve is associated with a variable orifice for controlling shock absorption damping of a leveling strut.

18. The system of claim 1, wherein each valve comprises a one-way valve.

19. The system of claim 18, wherein each one-way valve comprises a manual valve release.

20. The system of claim 1, wherein the plurality of valves are closed after all leveling struts have been compressed to isolate each of the plurality of leveling struts upon landing.

21. The system of claim 1, wherein each valve comprises an electric valve, and
wherein the system comprises:
a control circuit in electrical communication with each electric valve for controlling the electric valves.

22. The system of claim 21, comprising:
at least one sensor in electrical communication with each of the plurality of leveling struts and the control circuit,
wherein the at least one sensor is configured to detect at least one of an internal pressure of the adaptive portion and a displacement of the landing pad of each of the plurality of leveling struts.

23. The system of claim 1, wherein the aircraft comprises a vertical take off and landing (VTOL) ducted fan aircraft.

24. A method of auto-leveling landing gear of an aircraft, comprising the steps of:
a.) fluidly connecting an adaptive portion of each of a plurality of leveling struts to the adaptive portion of at least one other leveling strut,
wherein each adaptive portion comprises a fluid reservoir,
wherein each leveling strut comprises a landing pad,
wherein a change in a volume of fluid in the fluid reservoir of the adaptive portion is configured to cause a change in extension of the corresponding landing pad of the leveling strut, and
wherein for each of the plurality of leveling struts, the method comprises the steps of:
b.) compressing the leveling strut;
c.) forcing fluid from the adaptive portion of the leveling strut into the adaptive portion of the at least one other leveling strut to extend the landing pad of the at least one other leveling strut; and
d.) preventing fluid from flowing back into the adaptive portion of each leveling strut after step (b).

25. The method of claim 24, wherein each leveling strut comprises a shock absorbing portion.

26. The method of claim 25, wherein the shock absorbing portion comprises a shock absorber.

27. The method of claim 26, wherein the shock absorber comprises a fluid damper and spring device.

28. The method of claim 26, comprising the step of:
e.) positioning the adaptive portion of each leveling strut between the landing pad and the shock absorber.

29. The method of claim 25, comprising the step of:
e.) positioning the adaptive portion of each leveling strut between the shock absorbing portion and the aircraft.

30. The method of claim 25, comprising the step of:
e.) controlling shock absorption damping of each leveling strut.

31. The method of claim 24, comprising the step of:
e.) returning each leveling strut to an original position.
